(19) United States
(12) Patent Application Publication
(10) Pub. No.: US 2026/0336585 A1
(43) Pub. Date: Oct. 29, 2026

(54) ELECTROPNEUMATIC PARKING BRAKE DEVICE WITH PARKING BRAKE REDUNDANCY UNIT

(71) Applicant: ZF CV Systems Global GmbH, Bern (CH)

(72) Inventors: Robert Otremba, Ronnenberg (DE); Arne Michaelsen, Seelze (DE); Julian Van Thiel, Grossburgwedel (DE)

(21) Appl. No.: 19/701,584

(22) Filed: Jun. 8, 2026

Related U.S. Application Data
(63) Continuation of application No. PCT/EP2024/083574, filed on Nov. 26, 2024.

(30) Foreign Application Priority Data
Dec. 22, 2023 (DE) 10 2023 136 455.3

(51) Int. Cl. B60T 13/38; B60T 8/172; B60T 13/58; B60T 13/68; B60T 17/22

(52) U.S. Cl. CPC B60T 13/385; B60T 8/172; B60T 13/588; B60T 13/683; B60T 17/22; B60T 2270/402; B60T 2270/406; B60T 2270/413

(57) ABSTRACT

A parking brake device is for pressurizing and venting spring brake cylinders and includes a parking brake valve unit, and a parking brake redundancy unit, which, in order to vent at least one spring brake cylinder, is configured to connect a parking brake pressure air path to a ventilation independently of the parking brake valve unit. The parking brake redundancy unit has a first ventilation path having a main port for receiving a pressure of the parking brake pressure air path, a first and a second redundancy valve unit, and a redundant ventilation. The first redundancy valve unit is controllable by a first control unit. The second redundancy valve unit can be controlled by a second control unit. The parking brake redundancy unit is configured to connect the main port to the redundant ventilation to vent the main port. A method is for operating an electronically controllable pneumatic braking system.

### CROSS-REFERENCE TO RELATED APPLICATIONS

This application is a continuation application of international patent application PCT/EP2024/083574, filed Nov. 26, 2024, designating the United States and claiming priority from German application 10 2023 136 455.3, filed Dec. 22, 2023, and the entire content of both applications is incorporated herein by reference.

### TECHNICAL FIELD

The disclosure relates to an electropneumatic parking brake device for pressurizing and venting one or more spring brake cylinders of an at least partially electronically controllable pneumatic braking system for a vehicle, including an electropneumatic parking brake valve unit with a supply port for receiving reservoir pressure from a compressed-air reservoir, and a parking brake control unit, wherein the parking brake valve unit is configured to control a parking brake pressure at least at one spring accumulator port as a function of a parking brake signal. The disclosure further relates to an electronically controllable pneumatic braking system and a vehicle including such a braking system.

### BACKGROUND

Modern utility vehicles commonly have an electronically controllable pneumatic braking system. The braking system generally includes spring brakes as parking brakes, also referred to as immobilizing brakes. The parking brakes operate under the action of spring force, can be released by pressurization of spring brake cylinders with a parking brake pressure, and can be arrested by ventilation. Valves within a service brake system are electronically controlled in order to control a service brake pressure. The valves may be provided in, or outside, so-called axle modulators. The axle modulators may be automated or partially automated, and/or may be electronically controllable by an autonomous unit. The parking brakes are also electronically actuated. For example, the pressurization or ventilation of the spring brake cylinders can be controlled by actuation of a solenoid valve. The spring brake cylinders may be combined with service brake cylinders, such that the spring brake and service brake act on the same brake pistons. Suitable configuration measures may be implemented in order to avoid mechanical overloading of the brake pistons as a result of summation of braking forces from the service brakes and the spring brakes. If the service brakes are operated while the parking brakes are active, the spring brake cylinders are simultaneously pressurized in order to thus avoid summation of the braking forces. Such a function is also referred to as an "anti-compound function".

It must be possible for the parking brake to be engaged by a driver of the vehicle. In some markets, this is performed by way of an electronic parking brake demand to the parking brake device. In other markets, for safety reasons, the spring brake cylinders are ventilated if the reservoir pressure in the service brake system falls. Here, the service brake and parking brake may also be assigned to different brake circuits.

Safety concepts are of high relevance in electropneumatic braking systems for modern vehicles. In particular in vehicles with automated or partially automated driving functions, braking functions must remain available at least to a restricted degree even in the event of a fault or in the case of an electrical failure of a control unit. Only in this way can the safety of the vehicle, its occupants and other road users be ensured. For this purpose, it is known to provide redundancy levels that can continue to provide an at least restricted braking function even in the event of failure of a primary system.

Aside from the service brakes, a redundancy level is also desired for the parking brake, because in most cases, vehicles can be safely parked only with the parking brake engaged. To enhance functionality, and in particular to be able to pressurize and thus release the corresponding spring brake cylinders of the parking brake irrespective of the occurrence of a fault in any of the various levels, be it the service level or a redundancy level of the braking system, it is desirable for the spring brake cylinders to be capable of being controlled via two independent paths in order to vent them. This is intended to increase the range of functions and the operational readiness of the vehicle. Through the provision of a redundancy level, it is thus possible to ensure that the vehicle can be safely parked even in the event of one or more faults in the braking system.

DE 10 2021 122 497 A1 has disclosed a method for operating an electropneumatic braking system for a vehicle, wherein the braking system includes a service brake system and a parking brake system, wherein the parking brake system includes at least one spring brake cylinder. The method is characterized by the steps: providing, via a control unit, a control signal for maintaining a spring accumulator pressurization pressure with which the at least one spring brake cylinder is pressurized; stopping the provision of the control signal in the event of a fault and/or an electrical failure and/or in a diagnostic situation of the control unit; thus automatically ending the maintaining of the spring accumulator pressurization pressure in order to ventilate the at least one spring brake cylinder; thus triggering a spring accumulator failure braking operation of the vehicle via the parking brake system, with the spring accumulator pressurization pressure being vented by way of a service brake ventilation function of the service brake system. The service brake ventilation function makes it possible to realize at least one, in particular continuously or intermittently opened, ventilation path in the service brake system for the purposes of ventilating the at least one spring brake cylinder. The service brake ventilation function is implemented in particular via a valve in the service brake system, preferably an outlet valve and/or a further outlet valve.

Further partially redundant systems are known from DE 10 2022 101 142 A1, DE 10 2021 122 498 A1, DE 10 2021 122 499 A1, DE 10 2020 132 875 A1 and EP 3 145 769 B1.

Even though redundant options for engaging a parking brake have already been created in part by known systems, there is a demand for further improvements. In particular, in the case of the aforementioned known options, the outlay on assembly and production can be high, because the connection to the service brake system can require long line paths. Furthermore, the achievable system dynamics can be restricted.

It is therefore desirable to improve the engagement of a parking brake. In particular, the ventilation of at least one spring brake cylinder in a reliable manner and with low effort is to be made possible.

### SUMMARY

It is an object of the disclosure to provide an improved electropneumatic parking brake device which allows the ventilation of a spring brake cylinder in a simple and/or reliable manner even in the case of redundancy.

In a first aspect, the disclosure achieves this object with an electropneumatic parking brake device according to various embodiments of the disclosure. Starting from an electropneumatic parking brake device of the type mentioned above, an electropneumatic parking brake redundancy unit is further provided, which is configured to connect a parking brake pressure air path with a venting, independent of the electropneumatic parking brake valve unit for venting at least one spring brake cylinder, wherein the parking brake redundancy unit has a first ventilation path, which includes a main port for receiving a pressure of the parking brake pressure air path, a first electropneumatic redundancy valve unit, a second electropneumatic redundancy valve unit, and a redundant ventilation into the environment. The first electropneumatic redundancy valve unit is controllable by a first control unit, and the second electropneumatic redundancy valve unit is controllable by a second control unit, which is independent of the first control unit. The parking brake redundancy unit is configured to connect the main port via the first ventilation path of the parking brake redundancy unit to the redundant ventilation in order to vent the main port directly into the environment. In addition to the electropneumatic parking brake valve unit, the parking brake redundancy unit is thus also provided for venting a spring brake cylinder of the braking system and thus engaging the parking brake. The parking brake valve unit can connect a parking brake pressure air path to a ventilation. This connection can be made independently of the electropneumatic parking brake valve unit. This means that a spring brake cylinder can be bled even if the electropneumatic parking brake valve unit has a fault, is not supplied with power or is otherwise restricted in its function. The parking brake pressure air path is a compressed air path associated with the vehicle parking brake. This can be a compressed air path directly connected to one or more spring brake cylinders. For example, the parking brake pressure air path may be a compressed air path between the spring accumulator port of the parking brake valve unit and the spring accumulator of the spring accumulator brake cylinder. However, it may, for example, and preferably also be provided that the parking brake pressure air path is a supply path that connects a compressed-air reservoir of the braking system to the parking brake.

The parking brake redundancy unit includes at least one ventilation path. The first ventilation path connects a main port of the parking brake redundancy unit with a redundant ventilation into the environment. The redundant ventilation opens directly into the environment. There are therefore no other functional units of a braking system between the redundant ventilation and the surrounding area. However, it may be provided that the redundant ventilation includes one or more passive elements, such as a silencer and/or a line. In particular, no switchable components or modulators are arranged between the redundant ventilation and the environment. The direct connection of the redundant ventilation to the environment eliminates further sources of error. In addition, a high level of system dynamics can be achieved. In addition, line lengths can be reduced, which can reduce the assembly and manufacturing effort of the parking brake device. According to various embodiments, the first ventilation path is parallel to a primary ventilation path of the parking brake valve unit. The primary ventilation path connects the spring accumulator port of the parking brake valve unit to a primary ventilation of the parking brake valve unit. The first ventilation path of the parking brake redundancy unit and the primary ventilation path of the parking brake valve unit are preferably connected to each other at the spring accumulator port. However, it may also be provided that the first ventilation path and the primary ventilation path lead into a connecting line to the spring brake cylinder. In other variants, the first ventilation path and the primary ventilation path are completely separate.

The first electropneumatic redundancy valve unit can be controlled by a first control unit and the second electropneumatic redundancy valve unit can be controlled by a second control unit. The control units may be parking brake control units, but they do not need to be. According to various embodiments, the first control unit and/or the second control unit is a service brake control unit of a braking system. The second control unit is independent of the first control unit. As a result, a fail-safe parking brake device can be further increased, since in the event of a failure of one of the control units, the other control unit can continue to function.

In a first embodiment, the first control unit and/or the second control unit is independent of the parking brake control unit. This can ensure that at least one of the control units is independent of the parking brake control unit. In the event that only the parking brake control unit has a fault, at least the first control unit or the second control unit will continue to function. According to various embodiments, both the first control unit and the second control unit are independent of the parking brake control unit. However, variants may also provide that the first control unit or the second control unit is formed by the parking brake control unit, or that the parking brake control unit includes the first control unit or the second control unit.

According to various embodiments, the first electropneumatic redundancy valve unit has a bistable valve unit having a first position and a second position, wherein the first position is a ventilation position, in which the bistable valve unit allows a pneumatic connection of the main port with the redundant ventilation, and wherein the bistable valve unit in the second switching position interrupts the first ventilation path. In the second switch position, the bistable valve unit interrupts the first ventilation path, preventing air flow through the first ventilation path. For example, the bistable valve unit can prevent unwanted venting of a spring brake cylinder. In the first position, the bistable valve unit preferably releases the first ventilation path or allows at least a flow through the ventilation path through the bistable valve unit. The bistable valve unit is stable in the first position and in the second position and remains in the previously assumed position, especially in the de-energized state. For example, the bistable valve unit allows switching between an autonomous operating mode and a manual operating mode. For example, the bistable valve unit can only be in the first position in an autonomous operating mode of a braking system. In this case, venting of the parking brake path via the redundancy valve unit, for example, is only possible in an autonomous operation, for which redundancy is particularly important. The bistable valve unit may have one or more valves that provide the bistable functionality. In an embodiment, the bistable valve unit is or includes a bistable valve, preferably an electrically switchable bistable valve, particularly preferably an electrically switchable solenoid-operated bistable valve. In other variants, the bistable function of the bistable valve unit can also be achieved by suitable interconnection of several valves, which do not necessarily have to be configured as bistable valves.

According to various embodiments, the first electropneumatic redundancy valve unit has a first monostable holding valve, which is connected in series along the first ventilation path with the bistable valve unit, in particular a bistable valve of the bistable valve unit. The first monostable holding valve has only a stable condition. In the de-energized state, the monostable holding valve switches to this stable state. According to various embodiments, the monostable holding valve releases the first ventilation path in the de-energized state or in the stable state. In the de-energized state, the monostable holding valve then allows a flow through the same or is open. According to various embodiments, the first holding valve can be switched to a closed state by the first control unit. For example, and According to various embodiments, the first holding valve may be a solenoid valve which can be switched to a closed position by energizing an electromagnet. The first control unit can then, depending on the operation, switch the first holding valve to release the first ventilation path or not. In the event of a fault in the first control unit, the first holding valve automatically switches to the open state, thus allowing the parking brake to be engaged or the parking brake path to be bled even in the event of a fault (provided that any other valves along the first ventilation path also allow the same to flow through).

In a preferred variant, the second electropneumatic redundancy valve unit includes a second monostable holding valve, which is connected in series along the first ventilation path with the bistable valve unit, in particular a bistable valve of the bistable valve unit. The second monostable holding valve may preferably be formed in the same way as the first monostable holding valve. According to various embodiments, the first monostable holding valve of the first electropneumatic redundancy valve unit and the second monostable holding valve of the second electropneumatic redundancy valve unit are each preloaded into an open state and/or open in the de-energized state. In this case, the holding valves release the first ventilation path when they are de-energized. The parking brake redundancy unit then remains advantageously controllable even in the event of a partial fault. For example, if the first control unit has a fault and therefore the first monostable holding valve of the first electropneumatic redundancy valve unit does not supply electrical voltage, then the first holding valve switches to the open state and releases the section of the first ventilation path passing through the first holding valve. The second control unit, which continues to function in this scenario, can then release the first ventilation path by appropriately activating the second monostable holding valve, or not, to connect the main port to the redundant vent, and thus direct the pressure of the parking brake pressure path received at the main port into the environment.

In an embodiment of a variant of the electropneumatic parking brake device, the second monostable holding valve is arranged along the first ventilation path between the bistable valve unit, in particular a bistable valve of the bistable valve unit, and the first monostable holding valve.

According to various embodiments, the parking brake redundancy unit includes at least one pressure sensor. The pressure sensor is configured to sense a pressure in the first ventilation path. The pressure sensor is preferably connectable to the first control unit and/or the second control unit in order to provide corresponding signals to the detected pressure of the ventilation path for the first control unit and/or the second control unit. The pressure sensor allows the parking brake redundancy unit to be diagnosed with a condition. For example, a first control unit connected to the pressure sensor can use the pressure sensor to determine whether or not there is pressure at the main port of the parking brake redundancy unit. For example, if the main port is connected to a spring brake cylinder, the pressure sensor can be used to determine whether the parking brake is engaged or not. The pressure sensor is preferably configured for determining the pressure at the main port or for providing pressure signals that correspond to the pressure at the main port. However, the pressure sensor may also be provided, for example, for determining a pressure upstream or downstream of the bistable valve unit, in particular a bistable valve of the bistable valve unit, downstream or upstream of the first monostable holding valve or downstream or upstream of the second monostable holding valve. The flow direction is considered from the main port toward the redundant ventilation, so that the main port is located upstream of the redundant ventilation.

In a further embodiment, the parking brake redundancy unit includes a second redundant ventilation and a second ventilation path, which can be vented via the second redundant ventilation, wherein the bistable valve unit can be controlled via the second ventilation path. It should be understood that only one first valve of the bistable valve unit can be actuated via the second ventilation path, and that at least one second valve of the bistable valve unit for driving this first valve of the bistable valve unit can act on the second ventilation path, in particular the second ventilation path can enable, block and/or can vent via the second redundant ventilation

In an embodiment of the configuration with first and second ventilation path, the bistable valve unit includes a first electronically switchable monostable holding valve, which is arranged in the second ventilation path, and a pneumatically switchable third holding valve, in particular relay valve, which is arranged in the first ventilation path and includes a pneumatic control port connected to the second ventilation path. The second electropneumatic redundancy valve unit includes a second electronically switchable monostable holding valve, which is arranged in the first ventilation path. According to various embodiments, the third holding valve is open when a control pressure is provided at the pneumatic control port, which preferably exceeds a pressure limit value.

According to various embodiments, the parking brake redundancy unit further includes a return path, wherein the return path connects an outlet port of the third holding valve to the pneumatic control port of the third holding valve. The holding valve can then be self-locking as soon as it is initially switched to an open state.

According to various embodiments, a restrictor and/or a check valve is provided in the return path. The restrictor can throttle a compressed air flow through the return path. The check valve preferably prevents a compressed air flow from the pneumatic control port to the outlet port of the third holding valve. For example, the restrictor can prevent a high working pressure in the first ventilation path from preventing ventilation of the pneumatic control port. Thus, the restrictor then ensures, if necessary, that the pneumatic control port for interrupting the first ventilation path can be vented, in particular in the second ventilation path connected to the second control port is at least partially vented.

According to various embodiments, the parking brake device further has a flow limiter, which limits a maximum volume flow through the parking brake redundancy unit. The flow limiter may, for example, be configured as a bottleneck in the first ventilation path. Limiting the maximum flow rate can reduce the speed at which a parking brake pressure air path connected to the main port can be emptied via the parking brake redundancy unit or increase the time required to empty. For example, if the parking brake pressure air path is connected to the spring accumulator brake cylinder, the flow limiter can cause the parking brake to be applied gently because the parking brake cylinder is not purged abruptly. This is particularly advantageous if the parking brake is to be used to brake a moving vehicle in the event of redundancy. The flow limiter may be a passive element, in particular a restrictor, or a switchable component, for example an electronically controllable throttle valve.

In a second aspect, the disclosure solves the problem mentioned above with an electronically controllable pneumatic braking system for a vehicle including at least one first front axle brake actuator and a second front axle brake actuator for a front axle of the vehicle and at least one first rear axle brake actuator and a second rear axle brake actuator for a rear axle of the vehicle. The braking system further includes a primary system having a primary control unit at least for controlling the first front axle brake actuator and the second front axle brake actuator and/or for controlling the first rear axle brake actuator and the second rear axle brake actuator, and an electropneumatic parking brake device according to one of the embodiments described above according to the first aspect of the disclosure. The at least one spring accumulator port of the electropneumatic parking brake valve unit is preferably connected to at least one first spring accumulator brake cylinder. The primary system is preferably a service braking system of the vehicle. The primary control unit is typically independent of the parking brake control unit. The electropneumatic parking brake valve unit of the parking brake device is configured to pressurize a parking brake cylinder connected to the spring accumulator port (releasing the parking brake). Furthermore, the parking brake valve unit is preferably configured to vent the parking brake cylinder connected to the spring accumulator port. This is preferably done by corresponding signals from the parking brake control unit. The parking brake valve unit typically serves as the primary device for engaging and releasing the parking brake of the vehicle. The parking brake redundancy unit preferably provides redundancy for the parking brake valve unit and allows That the parking brake is applied even if the parking brake valve unit, in particular the parking brake control unit, has a fault. However, it should be understood that the main port of the parking brake redundancy unit does not need to be connected to the spring brake cylinder.

In a first embodiment of the braking system, however, the first spring brake cylinder is connected to the main port of the parking brake redundancy unit. The parking brake redundancy unit is preferably switchable to connect the spring accumulator brake cylinder to the redundant ventilation via the first ventilation path to vent the spring accumulator brake cylinder. In this case, the parking brake pressure air path is thus a compressed air path connected to at least one spring brake cylinder.

In an alternative embodiment of the electronically controllable pneumatic braking system, the main port is connected to a first compressed-air reservoir of the braking system. The parking brake redundancy unit is switchable to connect the compressed-air reservoir via the first ventilation path to the redundant ventilation to vent the first compressed-air reservoir. In this variant, the parking brake pressure air path is thus a compressed air path connected to a first compressed-air reservoir. The parking brake redundancy unit can connect the compressed-air reservoir to the redundant ventilation, causing a pressure drop in a braking system supply air path. This can then cause the parking brake to be engaged. For example, in braking systems for the North American market typically a so-called push-pull valve can be provided, which the parking brake automatically applies as soon as a supply pressure or reservoir pressure falls below a predefined pressure level.

According to various embodiments, the primary control unit is or includes the first control unit. The primary control unit can then control the first electropneumatic redundancy valve unit. Since the primary control unit and the parking brake control unit are typically independent units, the primary control unit can provide a level of redundancy for the parking brake control unit. This makes it particularly advantageous that an existing control unit can be used as a redundancy level. However, the first control unit may also be a separate control unit.

In an embodiment of the aforementioned embodiments, the electronically controllable pneumatic braking system further includes a secondary system having a secondary control unit, wherein the secondary system is configured to control the first front-axle brake actuator and the second front-axle brake actuator and/or to control the first rear-axle brake actuator and the second rear-axle brake actuator. According to various embodiments, the secondary system is configured to control the first front axle brake actuator and the second front axle brake actuator and/or to control the first rear axle brake actuator and the second rear axle brake actuator if a fault is determined in the primary system. The secondary system then preferably forms a redundancy level for the primary system, the redundancy level being provided in particular in vehicles with high levels of automation. The secondary system can therefore also be a redundant service braking system in particular.

According to various embodiments, the secondary control unit is or includes the second control unit. Even in this preferred variant, an existing control unit can then be used as redundancy for the parking brake control unit.

In a preferred variant the electronically controllable pneumatic braking system has a first voltage source and a second voltage source, wherein the first voltage source is provided for supplying electrical voltage to the first control unit, and wherein the second voltage source is provided for supplying electrical voltage to the second control unit. The provision of mutually independent voltage sources can further increase the fail-safety of the braking system, because a failure of a single voltage source does not result in a total failure of the parking brake system. The parking brake control unit may be connected to the first power source or to the second power source to provide electrical power.

According to a third aspect of the disclosure, the object mentioned in the introduction is achieved by a utility vehicle, having a front axle, at least one first rear axle and an electronically controllable pneumatic braking system according to any one of the above-described embodiments of an electronically controllable pneumatic braking system according to the second aspect of the disclosure.

In a fourth aspect, the disclosure solves the problem mentioned above with a method for operating an electronically controllable braking system for a vehicle. The braking system includes at least one spring brake cylinder and an electropneumatic parking brake device according to one of the embodiments of the first aspect of the disclosure described above, in which the first electropneumatic redundant valve unit includes a bistable valve unit. The spring accumulator port of the electropneumatic parking brake valve unit is connected to the at least one spring accumulator brake cylinder for pressurizing the spring accumulator brake cylinder with a parking brake pressure, and the main port of the electropneumatic parking brake redundancy unit is connected to a parking brake pressure air path of the braking system. The method includes the steps: determining whether there is an at least partially autonomous operating mode or a manual operating mode of the braking system; switching the bistable valve unit to the ventilation position if there is at least partially autonomous operating mode of the braking system; switching the bistable valve unit to the second switching position if the manual operating mode of the braking system is present; and pressurizing the at least one spring brake cylinder through the electropneumatic parking brake valve unit. The bistable valve unit, which preferably is or includes a bistable valve, is therefore preferably dependent on the present operating mode in the ventilation position, in which the bistable valve unit allows a pneumatic connection of the main port with the redundant ventilation, or switches to the second switching position in which the bistable valve unit interrupts the first ventilation path. A choice between the manual operating mode and the at least semi-autonomous operating mode can be made, for example, manually, by a human user, or automatically by an autonomous driving unit or another control unit of the vehicle. Venting of the spring brake cylinder is only possible in at least partially autonomous operating mode, since the bistable valve unit only releases the ventilation path in this case. In manual mode, a human operator is preferably present, so that a redundant ventilation function may not be necessary. In manual operation mode, the bistable valve unit can therefore interrupt the first ventilation path.

In a first embodiment, the method in the event that an at least partially autonomous operating mode of the braking system is present, further includes the steps: determining whether there is a fault in the electropneumatic parking brake valve unit, determining if there is a parking brake request, and at least intermittently interrupt the first ventilation path by a first holding valve and/or the bistable valve unit if no fault in the electropneumatic parking brake valve unit is determined and no parking brake request is determined; or opening the first holding valve and/or the bistable valve unit if a fault of the electropneumatic parking brake valve unit is determined and a parking brake request is determined to at least partially release the first ventilation path. If the electropneumatic parking brake valve unit has no fault or there is no fault with the electropneumatic parking brake valve unit, it can be assumed in many cases that the electropneumatic parking brake valve unit can vent the spring brake cylinder to engage the parking brake. Therefore, it is not usually necessary for the parking brake redundancy unit to vent the parking brake pressure air path as long as the electropneumatic parking brake valve unit is not faulty. In the event that the electropneumatic parking brake valve unit has a fault, the first holding valve and/or the bistable valve unit can be opened and at least partially release the ventilation path. However, the at least partial release occurs preferably only when a parking brake request is provided, for example by a unit for autonomous driving or by a human driver. Even if the first vent valve and/or the bistable valve unit partially releases the first ventilation path, it may still be provided that a second vent valve interrupts the first ventilation path.

In an embodiment, the method includes the step: at least secondarily interrupting the first ventilation path by a second holding valve, if no fault of the parking brake control unit is determined and no parking brake request is determined, wherein the at least temporary interrupting by the second holding valve is preferably then carried out, if the first holding valve releases the first ventilation path, no fault of parking brake control unit is determined and no parking brake request is determined. If there is no parking brake request, the first ventilation path can be interrupted alternately by the first hold valve (and/or the bistable valve unit) and the second hold valve, which can have a positive effect on the life of the hold valves.

According to various embodiments, the first holding valve and/or the bistable valve unit is actuated by a first control unit for at least secondary interruption of the first ventilation path and the second holding valve is actuated by a second control unit for at least secondary interruption of the first ventilation path. The first control unit and the second control unit are preferably connected, in particular via a CAN bus, and are configured to determine whether the other control unit releases or interrupts the first ventilation path.

It should be understood that the electronically controllable pneumatic braking system according to the second aspect of the disclosure, the utility vehicle according to the third aspect of the disclosure and the method for operating a braking system according to the fourth aspect of the disclosure have the same and similar sub-aspects.

### BRIEF DESCRIPTION OF DRAWINGS

The invention will now be described with reference to the drawings wherein:

FIG. 1 is a schematic illustration of a utility vehicle with an electronically controllable pneumatic braking system;

FIG. 2 is a schematic illustration of a first embodiment of a parking brake device;

FIG. 3 is a schematic illustration of a second embodiment of a parking brake device;

FIG. 4 is a schematic illustration of a third embodiment of a parking brake device;

FIG. 5 is a schematic illustration of a fourth embodiment of a parking brake device; and,

FIG. 6 is a schematic illustration of a fifth embodiment of a parking brake device.

### DETAILED DESCRIPTION

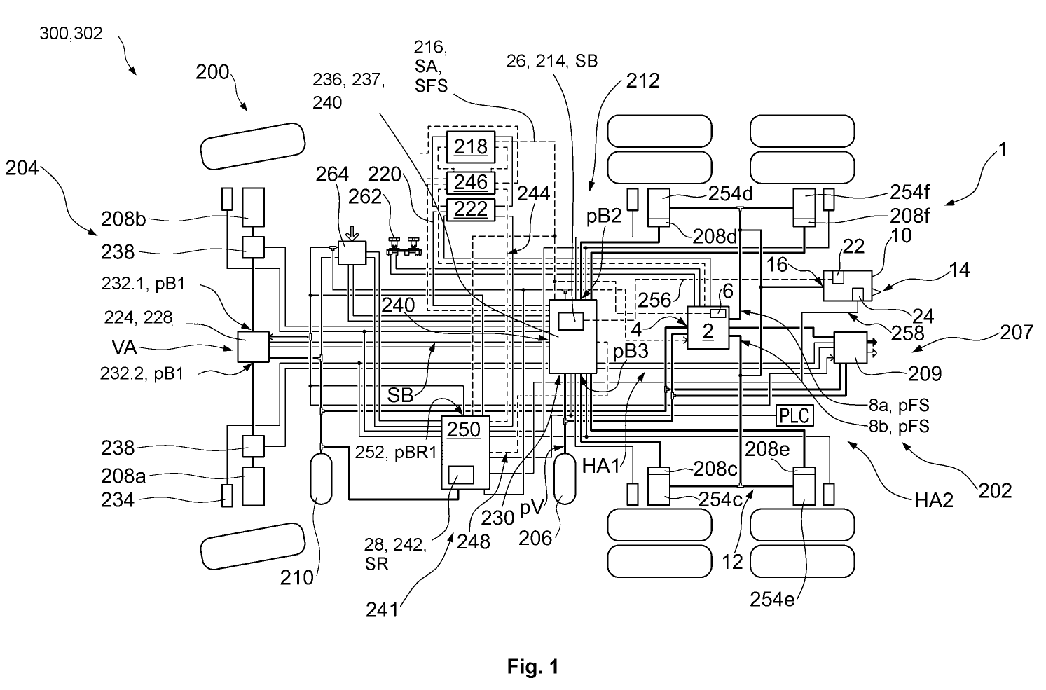

FIG. 1 shows an electronically controllable pneumatic braking system 200 having an electropneumatic parking brake device 1. The electronically controllable pneumatic braking system 200 is used in the present case in a vehicle 300 configured as a utility vehicle 302, which is illustrated here in highly schematic form, in particular with a front axle VA, a first rear axle HA1 and a second rear axle HA2.

Here, the electronically controllable pneumatic braking system 200 has first, second, third, fourth, fifth and sixth service brake actuators 208a-208f, for in each case one wheel of the vehicle 300. To supply the first to sixth service brake actuators 208a-208f with brake pressures, a rear axle brake circuit 202 and a front axle brake circuit 204 are provided. The service brake actuators 208a, 208bare assigned to the front axle VA and are therefore also referred to as front axle brake actuators 208a, 208b. Similarly, the service brake actuators 208c-208fassigned to the rear axles HA1, HA2 are also referred to as the rear axle brake actuators 208c-208f. The rear axle brake circuit 202 is supplied by a first compressed-air reservoir 206 and the front axle brake circuit 204 by a second compressed-air reservoir 210. The utility vehicle 300 is configured here as a towing vehicle and includes a trailer brake circuit 207 with a trailer module 209, which is provided for supplying a trailer connected to the utility vehicle 300 (not shown) with compressed air.

The electronically controllable pneumatic braking system 200 has an service level and a first redundancy level. In the service level, the electronically controllable pneumatic braking system 200 includes a primary system 212 having an electronic primary control unit 214 that controls the electronically controllable pneumatic braking system 200 in the service level. The electronic primary control unit 214 is connected via a vehicle bus 216 to an autonomous driving unit 218 and receives brake request signals SA from this. Furthermore, the electronic primary control unit 214 is connected via a first supply line 220 to a first voltage source 222 and is supplied with electrical power therefrom. The electronic primary control unit 214 converts the brake request signals SA and, based on this, outputs operating brake signals SB on a first service axle modulator 224. The first service axle modulator 224 is a front axle modulator 228 intended for the front axle VA. Alternatively or in addition, brake request signals SA can also be provided by an electronic foot brake pedal 264 on the primary control unit 214.

The first service axle modulator 224 is connected to the second compressed-air reservoir 210 and receives reservoir pressure pV therefrom. On the basis of the received service brake signals SB, the first service axle modulator 224 controls a first service brake pressure pB1 at a first service brake pressure port 232.1 and preferably a second service brake connection 232.2. The first service brake pressure pB1 is preferably modulated on a wheel-specific basis at the first and second service brake pressure ports 232.1, 232.2, and the first service axle modulator 224 is configured as a two-channel modulator. In other embodiments, the first service brake pressure port 232.1 and the second service brake pressure port 232.2 may however also be combined, and the first service axle modulator 224 may thus be configured as a single-channel axle modulator, which modulates the first service brake pressure pB1 on an axle-specific basis.

On the front axle VA, a first wheel speed sensor 234 is also provided, which provides first wheel speed signals SD at the primary control unit 214. The primary control unit 214 is configured to process the first wheel speed signals SD and to provide ABS switching signal to ABS valves 238 of the front axle VA in order to achieve slip control or ABS modulation of the first service brake pressure pB1 and to avoid blockage of the front wheels of the vehicle 300.

For braking the first and second rear axles HA1, HA2, the electronically controllable pneumatic braking system 200 includes a second service axle modulator 236 in the service level, which is provided for the first and second rear axles HA1, HA2 and can thus also be referred to as the rear axle modulator 237. In the embodiment shown in FIG. 1, the rear axle modulator 237 is installed with the electronic primary control unit 214 to a module, which is referred to here as central module 240. However, it should be understood that the rear axle modulator 237 and the primary control unit 214 can also be separate or structurally separate. The primary control unit 214 and the rear axle modulator 237 can then be connected to each other, for example, via a signal line or a bus line. Internally, the primary electronic control unit 214 controls the rear axle modulator 237 in accordance with the brake request signals SA received by the primary control unit 214 from the autonomous driving unit 218.

A supply port 230 of the second service axle modulator 236 is connected to the first compressed-air reservoir 206 and receives reservoir pressure pV from this. According to its activation by the primary control unit 214, the rear axle modulator 237 controls at least a second service brake pressure pB2, but in the embodiment shown here, it also controls a third service brake pressure pB3. The second service brake pressure pB2 is provided for the right side of the vehicle in the embodiment shown in FIG. 1 and the third service brake pressure pB3 is provided for the left side of the vehicle. The rear axle modulator 237 is thus configured here as a two-channel axle modulator. The second service brake pressure pB2 is intended for a fourth and sixth service brake actuator 208d, 208f, while the third service brake pressure pB3 is provided for a third and a fifth service brake actuator 208c, 208e. In other variants, the first service axle modulator 236 can also be configured as a single-channel modulator or as a multi-channel modulator with more than two outputs.

In the redundancy level, the electronically controllable pneumatic braking system 200 includes a secondary control unit 242 of a secondary system 241, which is provided for controlling the electronically controllable pneumatic braking system 200 in the event that the service level has one or more faults. The secondary control unit 242 can thus control the electronically controllable pneumatic braking system 200 for example in the event of an electrical failure in the first voltage source 222, an electronic fault in the primary control unit 214, or the like.

The electronic secondary control unit 242 is likewise connected via the vehicle bus 216 to the unit for autonomous driving 218, and from this likewise receives braking demand signals SA. In contrast to the primary control unit 214, the secondary control unit 242 is connected via a second supply line 244 to a second voltage source 246 and is supplied with electrical energy from this. The first and the second voltage sources 222, 246 are independent of one another, such that a failure in the first voltage source 222 does not lead to a loss of the second voltage source 246, and vice versa. The electronic primary control unit 214 and the electronic secondary control unit 242 are thus electrically independent of one another.

To be able to exchange signals, the primary control unit 214 and the secondary control unit 242 are connected to one another via a redundancy bus 248. In this way, the secondary control unit 242 can determine the availability of the primary control unit 214, and perform the control of the electronically controllable pneumatic braking system 200 only if the primary control unit 214 is not available or not properly available. In variants, however, communication between the primary control unit 214 and the secondary control unit 242 may for example also take place via the vehicle bus 216.

In the redundancy level, a redundancy axle modulator 250 is provided, which is connected to the secondary control unit 242 and receives redundancy braking signals SR from this. In the embodiment according to FIG. 1, the secondary control unit 242 is integrated into the redundancy axle modulator 250. In other variants, the secondary control unit 242 and the redundancy axle modulator 250 may however also be physically separate units.

The redundancy axle modulator 250 is connected to the second compressed-air reservoir 210, which is independent of the first compressed-air reservoir 206, such that the second compressed-air reservoir 210 can provide reservoir pressure pV even if the first compressed-air reservoir 206 has failed. In other embodiments, the redundancy axle modulator 250 can also be connected to the second compressed-air reservoir 210 or to the first compressed-air reservoir 206 and the second compressed-air reservoir 210.

The redundancy axle modulator 250 controls a redundancy brake pressure pBR1 at a redundancy brake pressure port 252 in accordance with the redundancy brake signals SR. The redundancy brake pressure pBR1 controlled at the redundancy brake pressure port 252 is provided to the front axle modulator 228. The redundancy axle modulator 250 is shown in FIG. 1 as a single-channel axle modulator with only one redundancy brake pressure port 252, but may also be configured as a multi-channel axle modulator, which can, for example, implement a side-appropriate control of redundancy brake pressures.

The secondary control unit 242 can control the redundancy axle modulator 250 in such a way that in the event of a fault of the primary control unit 214, a brake pressure, namely the redundancy brake pressure pBR1 is provided at the front axle brake actuators 208a, 208b. Unlike that shown in FIG. 1, the redundancy level can also be provided for braking the first and second rear axles HA1, HA2. This can be realized via the redundancy axle modulator 250 or via a second redundancy axle modulator. The secondary control unit 242 can then preferably also be provided for controlling such a second redundancy axle modulator.

The brake actuators assigned to the wheels of the rear axles HA1, HA2 are configured here as double-acting brake actuators, also referred to as Tristop cylinders. Aside from the service brake actuators 208c-208f, the brake actuators each also include a spring brake cylinder 254c-254f. The spring brake cylinders 254c-254fare configured to apply the brakes of the vehicle 300 when unpressurized or ventilated. The spring brake cylinders 254c-254fcan thus advantageously be utilized as parking brakes, because no compressed air needs to be provided in order to brake the rear axles HA1, HA2. To release the rear wheels, the spring brake cylinders 254c-254fmust be pressurized with a parking brake pressure pFS. This parking brake pressure pFS acts counter to the spring accumulators and releases the brakes of the vehicle 300.

To provide the parking brake function, the braking system 200 includes the parking brake device 1. This includes an electropneumatic parking brake valve unit 2, which is supplied with reservoir pressure pV via a supply port 4. In the embodiment shown, the supply port 4 is connected to the first compressed-air reservoir 206. In this case, the parking brake valve unit 2 is also supplied with reservoir pressure pV from the second compressed-air reservoir 210. In other variants, the electropneumatic parking brake valve unit 2 can alternatively or additionally be connected to a third compressed-air reservoir, which is preferably independent of the first compressed-air reservoir 206 and the second compressed-air reservoir 210. It should be understood that the electropneumatic parking brake valve unit 2 can only be supplied from the first compressed-air reservoir 206, only from the second compressed-air reservoir 210, only from the third compressed-air reservoir 206, from at least two compressed air supplies or from the first compressed-air reservoir 206, from the second compressed-air reservoir 210 and from the third compressed-air reservoir.

The electropneumatic parking brake valve unit 2 includes a parking brake control unit 6 that is connected via the vehicle bus 216 to the unit for autonomous driving 218. To engage the parking brake, the vehicle unit for autonomous driving 218 provides a parking brake signal SFS to the parking brake control unit 6 via the vehicle bus 216, and the parking brake control unit thereupon provides the parking brake pressure pFS at a first spring accumulator port 8a and at a second spring accumulator port 8b. In FIG. 1, the first spring accumulator port 8a is connected to the spring brake cylinders 254d, 254f, and the second spring accumulator port 8b is connected to the spring brake cylinders 254c, 254e. By providing the parking brake pressure pFS, the electropneumatic parking brake valve unit 2 pressurizes the spring brake cylinders 254c-254fand thus releases the parking brake. To engage the parking brake of the vehicle 300, the electropneumatic parking brake valve unit 2 can ventilate the spring accumulator ports 8a, 8b and the spring brake cylinders 254c-254f connected thereto. This may be performed in response to corresponding second parking brake signals being received at the parking brake control unit 6, or when parking brake signals SFS are no longer being provided by the parking brake control unit 6.

To provide redundancy for the electropneumatic parking brake valve unit 2, the electropneumatic parking brake device 1 further includes an electropneumatic parking brake redundancy unit 10. The parking brake redundancy unit 10 is configured to vent at least one of the spring brake cylinders 254c-254findependently of the electropneumatic parking brake valve unit 2. This may be implemented directly or indirectly. Thus, the parking brake redundancy unit 10 can, as shown in the embodiment according to FIG. 1, connect a parking brake pressure air path 12, which is directly connected to the spring brake cylinders 254c-254f, with a redundant ventilation 14. In alternative variants, the parking brake pressure air path 12 can also be connected to the first compressed-air reservoir 206 and/or the second compressed-air reservoir 210. Furthermore, the parking brake pressure air path 12 can alternatively or additionally also be connected to a third compressed-air reservoir, which is not shown in FIG. 1. The parking brake redundancy unit 10 then connects this parking brake pressure air path 12 connected to the first compressed-air reservoir 206, the second compressed-air reservoir 210 or a third compressed-air reservoir to the redundant ventilation 14 in order to cause the spring accumulator brake cylinders 254c-254f. The parking brake redundancy unit 10 can therefore be used for venting only one compressed-air reservoir 206, 210 or for venting several compressed air supplies 206, 210.

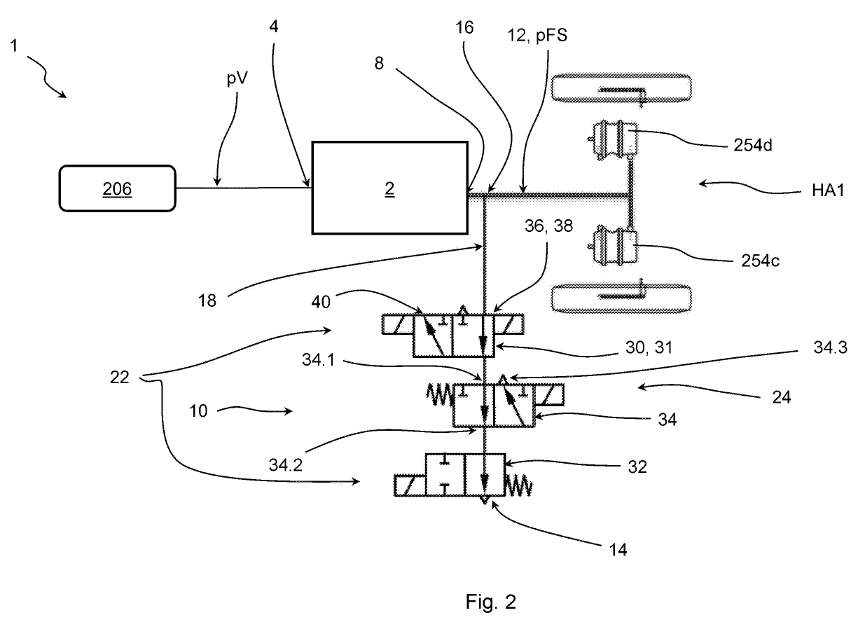

The parking brake redundancy unit 10 includes a main port 16, which is provided for connecting to the parking brake pressure air path 12. In FIG. 1, the spring brake cylinders 254c-254fare connected directly to the main port 16 and the spring accumulator port 8a, 8b. In the embodiment shown in FIG. 1, the parking brake redundancy unit 10 thus receives the parking brake pressure pFS at the main port 16, if the parking brake of the vehicle 300 is released or the spring brake cylinders 254c-254fare pressurized. The parking brake redundancy unit 10is configured to connect the main port 16 via a first ventilation path 18 (see FIG. 2) to the redundant ventilation 14. Via the first ventilation path 18, the holding pressure pFS can be vented directly into the environment in the embodiment according to FIG. 1. Thus, even if venting via the electropneumatic parking brake valve unit 2 should no longer be possible due to a fault, the parking brake cylinders 254c-254f can be connected via the first ventilation path 18 to the redundant ventilation 14 or the environment and thus be bled.

FIG. 1 also shows schematically a first electropneumatic redundancy valve unit 22 and a second electropneumatic redundancy valve unit 24. The first redundancy valve unit 22 can be controlled by a first control unit 26, which is the primary control unit 214 in the embodiment shown. For this purpose, the first redundancy valve unit 22 is connected to the primary control unit 214 via a first redundancy signal line 256. The second redundancy valve unit 24 can be controlled in an analogous manner by a second control unit 28, which is formed here by the secondary control unit 242. The connection between the secondary control unit 242 and the second redundancy valve unit 24 is made via a second redundancy signal line 258. The primary control unit 214 and the secondary control unit 242 are independent of each other and are supplied from separate voltage sources 222, 246, so that by using the primary control unit 214 as the first control unit 26 and the secondary control unit 242 as the second control unit 28, a redundancy level with high fail-safety can be created in a particularly simple manner.

In the embodiment shown in FIG. 1, both the first control unit 26 and the second control unit 28 are independent of the parking brake control unit 6. In other embodiments, however, for example, the parking brake control unit 6 may form or include the first control unit 26 or the second control unit 28.

FIG. 2 shows now schematically a first embodiment of the electropneumatic parking brake device 1, wherein for simplification further also the first rear axle HA1 with the associated parking brake cylinders 254c, 254D is shown. The electropneumatic parking brake valve unit 2 is shown schematically, wherein the spring accumulator ports 8a, 8b are shown here simplified as a common spring accumulator port 8. The main port 16 is also shown in a very simplified manner and flows into the parking brake pressure air path 12, which is a connecting line between the spring accumulator port 8 of the parking brake valve unit 2 and the spring accumulator brake cylinders 254c, 254D.

The first ventilation path 18 of the parking brake redundancy unit 10 connects the main port 16 indirectly with the redundant ventilation 14. In the first embodiment shown in FIG. 2, the parking brake redundancy unit 10 includes a total of three valves. The first redundancy valve unit 22 includes a bistable valve unit 30, which is formed here as a bistable valve 31, and a first monostable holding valve 32. The second redundancy valve unit 24 has here only a second monostable holding valve 34. The bistable valve 31, the second monostable holding valve 34 and the first monostable holding valve 32 are connected in series along the first ventilation path 18, wherein the second holding valve 34 is arranged between the bistable valve 31 and the first holding valve 32. The second monostable holding valve 34 is thus arranged along the first ventilation path 18 downstream of the bistable valve 1 and upstream of the first monostable holding valve 32.

In FIG. 2, the first control unit 26 and the second control unit 28 are not shown. However, it should be understood that the bistable valve 1 and the first monostable holding valve 32 of the first redundancy valve unit 22 can be controlled by the first control unit 26. The second monostable holding valve 34, on the other hand, can be controlled by the second control unit 28.

Here, the first monostable holding valve 32 and the second monostable holding valve 34 are each configured as electrically switchable solenoid valves. The first holding valve 32 is a 2/2-way valve, which is preloaded into an open state in which the holding valve 32 releases the first ventilation path 18. In the embodiment shown, the first holding valve 32 can be energized by the first control unit 26, so as to switch the first holding valve 32 into a closed state in which it interrupts the first ventilation path 18. The spring accumulator pressure pFS received from the parking brake pressure air path 12 at the main port 16 cannot then be bled into the environment via the parking brake redundancy unit 10. As long as the first control unit 26 is functional, this can prevent venting of the spring brake cylinders 254c, 254D.

The second holding valve 34 is configured as a 3/2 directional valve. In the state shown in FIG. 2, in which the second holding valve 34 is preloaded, the second holding valve 34 releases the first ventilation path 18. For this purpose, it connects a first path port 34.1 with a second path port 34.2. In the second position not shown in FIG. 2, the second path connection 34.2 is connected to a venting 34.3 and the first ventilation path 18 is interrupted. The ventilation 34.3 of the second holding valve 34 is shown here as a separate ventilation, but can also be the redundant ventilation 14. The second control unit 28 can switch the second monostable holding valve 34 from the open position illustrated in FIG. 2 to the closed position not shown, in which it powers the second holding valve 34 or its electromagnets. The second control unit 28 can thus prevent venting of the parking brake pressure air path 12 by switching the second monostable holding valve 34 to the closed state. When closed, the second path port 34.2 is connected to the vent 34.3 and the parking brake pressure air path 12 is interrupted.

The bistable valve unit 30, which is formed here by the bistable valve 30, has a first position 36, which is also referred to in the present case as ventilation position 38, and a second position 40. The first control unit 26 is configured to switch the bistable valve unit 30 between these two positions 36, 40. In the ventilation position 38, the bistable valve 31 releases the first ventilation path 18 and thus allows a pneumatic connection of the main port 16 with the redundant venting 14, if also the holding valves 32, 34 are open. The bistable valve unit 30 is stable in both the first position 36 and the second position 40. If the bistable valve 31 is not actuated by the first control unit 26, it remains in the last assumed position 36, 40. Thus, the bistable valve 31 remains, for example, in the ventilation position 38, If the second control unit 26 has an error and can no longer provide switching signals for the bistable valve 31 or the bistable valve unit 30.

In the embodiment shown, the bistable valve unit 30 can be used to switch between a manual operating mode and an autonomous operating mode of the braking system 200. In manual mode, a human driver takes over at least some of the control tasks of the vehicle 300. In the event that one of the control units 6, 26, 28, 218 of the braking system 200 fails or has a fault, the human operator can take over the task of this control unit 6, 26, 28, 218. A level of redundancy for the parking brake control unit 6 of the parking brake valve unit 2 may not be necessary. In such cases, the bistable valve 31 can be switched to the second switching position 40. The first ventilation path 18 is then permanently interrupted by the bistable valve 31 and it is not possible to vent the parking brake pressure air path 12 via the parking brake redundancy unit 10.

In the (partially) autonomous operation of the vehicle 300, the parking brake of the braking system 200 is generally to be safely engaged even if the parking brake control unit 6 of the parking brake valve unit 2 has an error and it is not possible to vent the spring storage brake cylinders 254c, 254D via the parking brake valve unit 2. In this case, the bistable valve 31 of the first redundancy valve unit 22 can be switched to the ventilation position 38. This is done, for example, when the vehicle 300 is commissioned or when the vehicle starts to drive. In the ventilation position 38, the bistable valve 31 releases the first ventilation path 18 and thus allows the parking brake pressure air path 12 to be immediately bled via the parking brake redundancy unit 10.

Especially in autonomous operation of the vehicle 300, various error scenarios are conceivable. If only the parking brake control unit 6 has a fault, the parking brake redundancy unit 10 can vent the parking brake pressure air path 12. For this purpose, the first control unit 26 must open the first holding valve 32 and the second control unit 28 must open the second holding valve 34 while the bistable valve 31 is in the ventilation position 38. The main port 16 is then fluid-conductively connected to the redundant ventilation 14 and the parking brake pressure air path 12 can be vented directly into the environment. A functional control unit 26, 28 can prevent venting of the parking brake pressure air path 12 by appropriately energizing the first holding valve 32 or the second holding valve 34.

In the first embodiment shown in FIG. 2, each of the control units 26, 28 can prevent the venting of the parking brake pressure air path 12, since the first holding valve 32 and the second holding valve 34 are connected in series. Even if, for example, the first control unit 26 has an error and the first monostable holding valve 32 switches to the open position shown in FIG. 2, the second control unit 28 can power the second monostable holding valve 34 and thus interrupt the first ventilation path 18.

In the event that both the first control unit 26 and the second control unit 28 have a fault, the parking brake redundancy unit 10 is also configured in the first embodiment according to FIG. 2 for providing an emergency braking function. The first monostable holding valve 32 and the second monostable holding valve 34 are each preloaded in an open state and therefore release the first ventilation path 18 as soon as these are not powered by the first control unit 26 or the second control unit 28. If the bistable valve 31 is also in the ventilation position 38, then in the event of a fault of the first control unit 26 and the second control unit 28, the main port 16 is automatically fluid-conductively connected to the redundant ventilation 14 and the parking brake pressure air path 12 is immediately vented. In the first embodiment, the locking pressure pFS is thus vented into the environment and the spring brake cylinders 254c, 254D brake the first rear axle HA1. To prevent the wheels of the first rear axle HA1 from locking, a flow limiter not shown may be provided in the first ventilation path 18. This can prevent sudden emptying of the spring accumulator brake cylinders 254c, 254D, which can lead to a blockage of the wheels of the first rear axle HA1.

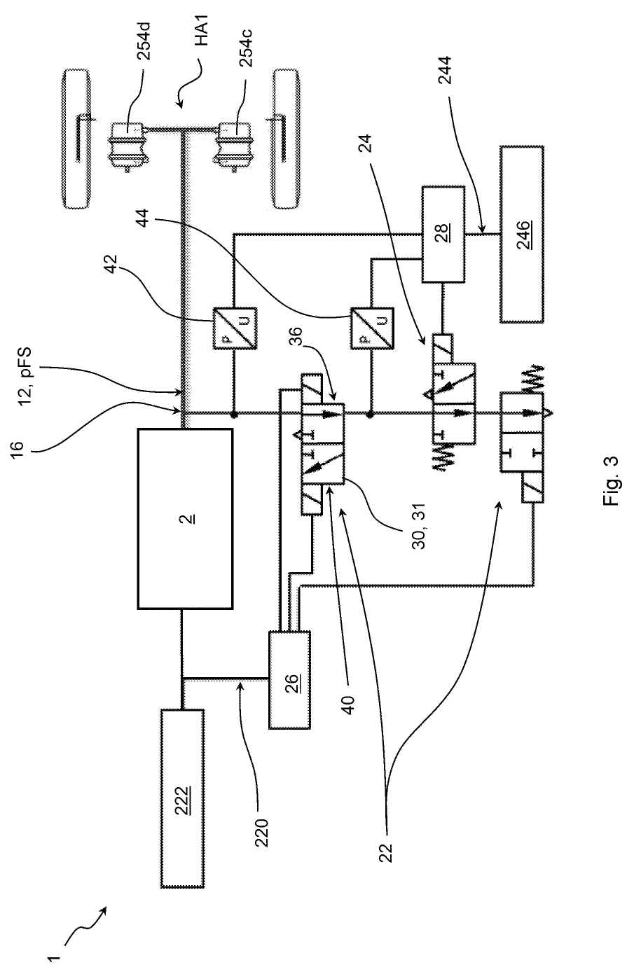

FIG. 3 illustrates a second embodiment of the parking brake device 1, wherein the illustration is substantially analogous to the first embodiment. In FIG. 3, in addition to the parking brake valve unit 2 and the parking brake redundancy unit 10, the first control unit 26 and the second control unit 28 are also shown. The first control unit 26 is supplied with electrical voltage from the first voltage source 222, which is also shown. The first voltage source 222 is also connected to the parking brake valve unit 2. By contrast, the second control unit 28 is supplied with electrical voltage from the second voltage source 246. The separate supply of voltage to the first control unit 26 and to the second control unit 28 means that a failure of one of the voltage sources 222, 246 does not lead to a total failure of the parking redundancy unit 10.

The first redundancy valve unit 22 and the second redundancy valve unit 24 are substantially identical to the first embodiment (FIG. 2) in the second embodiment (FIG. 3). Here, however, the parking brake redundancy unit 10 further includes a first pressure sensor 42 and a second pressure sensor 44. Both pressure sensors 42, 44 are configured for detecting a pressure of the first ventilation path 18. The first pressure sensors 42, 44 are connected to the second control unit 28 and provide signals, which correspond to the detected pressure, to the second control unit 28. In other variants of the parking brake device 1, the first pressure sensor 42 and/or the second pressure sensor 44 can also be connected to the first control unit 26.

In the second embodiment according to FIG. 3, the first pressure sensor 42 is provided for detecting a pressure present at the main port 16. The second control unit 28 is configured to use the signals from the first pressure sensor 42 to determine what pressure is prevailing at the main port 16. In the embodiment shown, the second control unit 28 can determine, for example, whether the parking brake pressure pFS is applied to the parking brake pressure air path 12 or whether the spring brake cylinders 254c, 254D are pressurized or vented. For this purpose, the first pressure sensor 42 for detecting the pressure upstream of the bistable valve 31 of the bistable valve unit 30 is arranged. The second pressure sensor 44 is configured to determine the pressure downstream of the bistable valve 31. The second control unit 28, which is not provided here for controlling the bistable valve unit 30, can thus determine, using the signals of the first pressure sensor 42 and the second pressure sensor 44, whether the bistable valve unit 30 is in the first switching position 36 or in the second switching position 40.

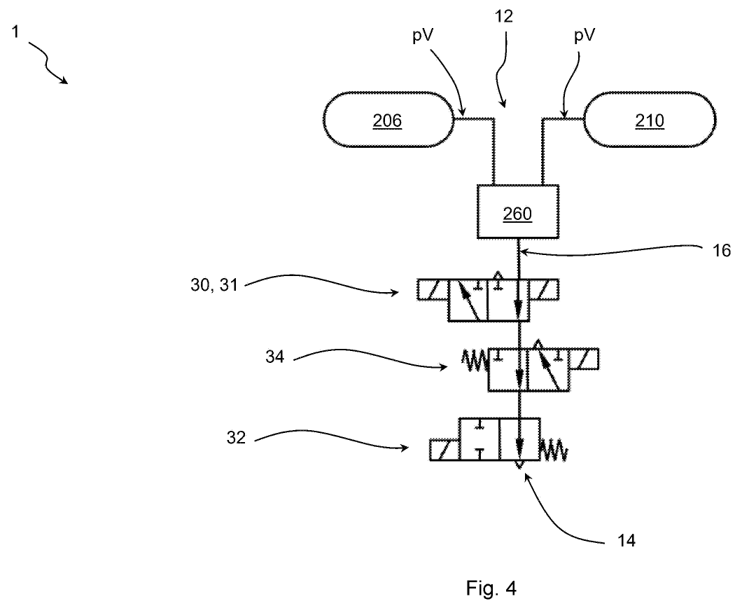

FIG. 4 illustrates a third embodiment. The parking brake redundancy unit 10 is configured in the same way as the first embodiment. In this variant of the braking system 200, however, the parking brake pressure air path 12 is not a direct connection between the parking brake valve unit 2 and spring brake cylinders 254c-254f, but a supply path. The main port 16 is connected via a Select-High valve 260 to the first compressed-air reservoir 206 and to the second compressed-air reservoir 210. However, it should be understood that the Select-High valve 258 can also be omitted and/or that the main port 16 also only with the first compressed-air reservoir 206, only with the second compressed-air reservoir 210, only with a third compressed-air reservoir and/or with at least two compressed air supplies from the first compressed-air reservoir 206, the second compressed-air reservoir 210 and a third compressed-air reservoir can be connected.

For venting at least one spring brake cylinder 254c-254fof the braking system 200 of the vehicle 300, the parking brake redundancy unit 10 connects the main terminal 16 to the redundant ventilation 14. The first compressed-air reservoir 206 and the second compressed-air reservoir 210 are thus immediately vented. This causes the pressure level of the reservoir pressure pV to drop. As soon as the pressure level of the reservoir pressure pV falls below a predefined pressure limit value, a push-pull valve 262 shown in FIG. 1 automatically voids the spring brake cylinders 254c-254f. In the third embodiment according to FIG. 4, the parking brake redundancy unit 10 therefore connects the parking brake pressure air path 12 connected to the first compressed-air reservoir 206 and the second compressed-air reservoir 210 with the ventilation 14 in order to indirectly vent at least one spring brake cylinder 254c-254f. Alternatively or as a supplement, a corresponding function within the parking brake valve unit 2 can automatically vent the spring brake cylinders 254c-254fif the pressure level of the reservoir pressure pV falls below the predefined limit value.

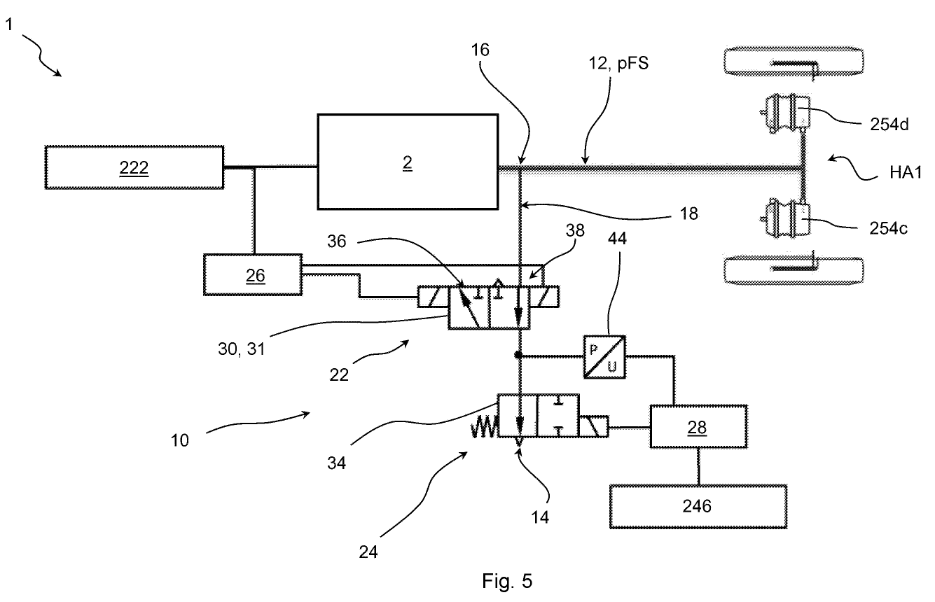

A fourth embodiment of a parking brake device 1 is illustrated in FIG. 5, wherein, analogous to the first and second embodiment, a parking brake pressure air path 12 and the first rear axle HA1 with the spring storage brake cylinders 254c, 254D are shown in addition. Similarly to the second embodiment illustrated in FIG. 3, the first control unit 26, the second control unit 28, the first voltage source 222 and the second voltage source 246 are further shown in FIG. 5.

In the fourth embodiment, the first redundancy valve unit 22 includes only the bistable valve unit 30, which here again includes only the bistable valve 31. The first monostable holding valve 32 is omitted in this variant. The second redundancy valve unit 24 again includes only the second monostable holding valve 34. The bistable valve 31 is arranged upstream of the second holding valve 34. For detecting a pressure downstream of the bistable valve 31, the second pressure sensor 44 is again provided, which is connected here to the second control unit 28. By providing only one monostable holding valve 34, the parking brake redundancy unit 10 according to the fourth embodiment can be produced cost-effectively. In order to be able to vent the parking brake pressure air path 12 even in the event of a fault of the first control unit 26 or the first voltage source 222 using the parking brake redundancy unit 10, the bistable valve 31 is preferably switched to the ventilation position 38 when commissioning the braking system 200. The bistable valve 1 retains the ventilation position 38 even if it is de-energized due to a fault of the first control unit 26 or a failure of the first voltage source 222. In error-free driving mode, the second control unit 28 keeps the second monostable holding valve 34 in the closed state and thus prevents unwanted venting of the parking brake pressure air path 12. In the event of a fault in the second control unit 28, the second holding valve 34 automatically switches to the open state and releases the first ventilation path 18. The still functional first control unit 26 can then optionally switch the bistable valve 31 to the second switching position 36, To prevent venting of the parking brake pressure air path 12.

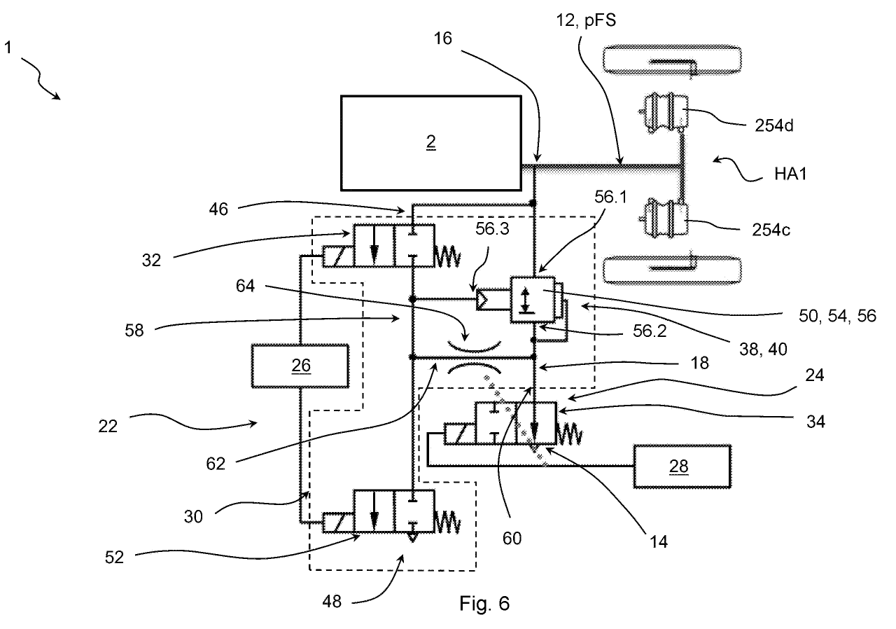

FIG. 6 illustrates a fifth embodiment of a parking brake device 1 of a braking system 200, wherein the illustration is substantially analogous to FIG. 5. For simplification, the voltage sources 222, 246 in FIG. 6 were omitted.

The parking brake redundancy unit 10 according to the fifth embodiment provides substantially analogous functionality as the parking brake redundancy unit 10 of the fourth embodiment illustrated in FIG. 5. The bistable valve unit 30, however, does not include a bistable valve 31, wherein a bistable valve 31 could be provided in principle. The bistable function of the bistable valve unit 30 is provided in the fifth embodiment via several valves 32, 50, 52. The bistable valve unit 30 is illustrated in FIG. 6 by a dashed line around its valves 32, 50, 52.

The parking brake redundancy unit 10 is also configured to connect the parking brake pressure air path 12 to a redundant ventilation 14. For this purpose, a first ventilation path 18 is provided again, via which the main port 16 can be connected to the first redundant ventilation 14. This first ventilation path 18 serves as the primary ventilation path for venting the parking brake pressure air path 12. In the fifth embodiment (FIG. 6), a second ventilation path 46 is additionally provided. The main port 16 can be connected via the second ventilation path 46 to a second redundant ventilation 48. In principle, a spring brake cylinder 254c-254fcan also be bled via the second ventilation path 46. The second ventilation path 46 is used in the fifth embodiment of the parking brake redundancy unit 10 but primarily for controlling the bistable function of the bistable valve unit 30. The second ventilation path 46 can be used in other embodiments (see analogously FIG. 4), but alternatively or additionally, in order to vent a locking air path 12 directly into the environment connected to at least one compressed-air reservoir 206, 210 and thus indirectly to vent a spring brake cylinder 254c-254f.

The first redundancy valve unit 22 of the fifth embodiment of a parking brake device 1 illustrated in FIG. 6 includes the bistable valve unit 30, which includes a first monostable holding valve 32, a third holding valve 50 and a fourth electrically switchable holding valve 52. The second redundancy valve unit 24, on the other hand, analogous to the fourth embodiment (FIG. 5), again includes only the second electronically switchable holding valve 34.

The fourth holding valve 52 and the first holding valve 32 are each configured as a 2/2-way valve, which is preloaded into a closed state. The second holding valve 34 is also configured as a 2/2-way valve, but here preloaded into an open state. The fourth holding valve 52 is configured as a solenoid valve and can be controlled by the first control unit 26. The first control unit 26 also controls the first holding valve 32. The second control unit 28 can power the second holding valve 32 and thus block the first ventilation path 18. In the event of a failure of the second control unit 28, the second holding valve 34 releases the first ventilation path 18, since the second holding valve 34 is de-energized in this case.

In the embodiment according to FIG. 6, the bistable valve unit 30 is configured in analogy to the embodiment according to FIG. 5 to enable or disable the first ventilation path 18 extending from the main port 16 to the first redundant ventilation 14. For this purpose, the bistable valve unit 30 includes a ventilation position 38 and a second switching position 40, analogous to the bistable valve 31. In the ventilation position 38, the third holding valve 50 releases the ventilation path 18 and connects the main port 16 fluid-conductively with the second holding valve 34. In the second switching position 40, the third holding valve 50 interrupts the first ventilation path 18. The bistable function of the bistable valve unit 30 is controllable by the first control unit 26, which controls the first holding valve 32 and the fourth holding valve 52.

The third holding valve 50 is a pneumatically switchable valve 54, namely a relay valve 56. The relay valve 56 has an input port 56.1, an outlet port 56.2 and a pneumatic control port 56.3. By applying a pneumatic control pressure to the pneumatic control port 56.3, the relay valve 56 can be switched to an open state in which the input port 56.1 is connected to the outlet port 56.2 in a fluid-conducting manner. The relay valve 56 can thus be switched by providing a pneumatic control pressure at the control port 56.3 in such a way that it releases the first ventilation path 18. Here, the bistable valve unit 30 is then in the ventilation position 38. If the second holding valve 34 is also open, the parking brake pressure air path 12 connected to the main port 16 can be connected and vented via the relay valve 56 and the second holding valve 34 to the first redundant ventilation 14.

The pneumatic control port 56.3 is connected to the second ventilation path 46. The relay valve 56 and thus the bistable valve unit 30 can thus be controlled via the second ventilation path 46. The second ventilation path 46 is used in the embodiment shown substantially for controlling the relay valve 56 or for providing the bistable function of the bistable valve unit 30 and can therefore also be referred to as a control path. The pneumatic control pressure of relay valve 56 can be initially provided via the second ventilation path 46. The parking brake pressure pFS present in the parking brake pressure air path 12 is also provided via the main port 16 on the first holding valve 32. The first control unit 26 can energize the first holding valve 32 and thus switch to an open state while keeping the fourth holding valve 52 closed to prevent venting of the parking brake pressure air path 12. The holding pressure pFS thus reaches a first path section 58 of the second ventilation path 46, which connects the first holding valve 32 to the fourth holding valve 52. The pneumatic control port 56.3 of the relay valve 56 is connected to this first path section 58 and the relay valve 56 switches to the open state when the locking pressure pFS is applied. The bistable valve unit 30 is then in the ventilation position 38.

In the ventilation position 38 of the bistable valve unit 30, the parking brake pressure pFS, which is also applied to the input port 56.1 via the main port 16, passes through the relay valve 56 to the outlet port 56.2. The second control unit 28 powers the second holding valve 34 and keeps it closed. The locking pressure pFS is therefore included in a second path section 60, which connects the relay valve 56 to the second holding valve 34.

The second path section 60 of the first ventilation path 18 is connected via a return path 62 to the first path section 58 of the second ventilation path 46. Through the return path 62, the outlet port 56.2 of the relay valve 56 is connected to the control port 56.3 of the relay valve 56 and the relay valve 56 can hold itself in the open state. Even if the first control unit 26 closes the first holding valve 32 or the first holding valve 32 switches automatically to the closed state due to a fault of the first control unit 26, the relay valve 56 remains in the open switching position, since via the second path section 60, The return path 62 and the first path section 58 are still subject to pFS holding pressure at the pneumatic control port 56.3.

The relay valve 56 or the bistable valve unit 30 is thus stable in the ventilation position 38. By briefly opening the first holding valve 32, in particular at the start of operation of the vehicle 300, the relay valve 56 can be brought into a self-holding state in which the relay valve 56 also remains when the first holding valve 32 is closed again. Even if the first control unit 26 has an error, it is still possible to vent the first parking brake pressure air path 12 via the first ventilation path 18. The second control unit 28, which is still functional, can power the second holding valve 34 and keep it closed or interrupt the first ventilation path 18. If the parking brake of the vehicle 300 is to be applied, the second control unit 28 no longer supplies the second holding valve 34 with electrical voltage and thus switches the second holding valve 34 to the open state. The spring accumulator pressure pFS can then be vented into the environment via the first ventilation path 18 and the first redundant ventilation 14.

If only the second control unit 28 has an error, the first control unit 26 can control the bistable valve unit 30 to enable or disable the first ventilation path 18. The release is carried out in the same way as the above description by pressurizing the pneumatic control port 56.3 via the first holding valve 32. To block the first compressed air path 18, the first control unit 26 opens the fourth holding valve 52 and thus connects the first path section 58 of the second ventilation path 46 with the second redundant venting 48. This also voids the pneumatic control port 56.3 of relay valve 56 and closes relay valve 56. The bistable valve unit 30 is then in the second switching position 40.

In the fifth embodiment shown, the return path 62 includes a restrictor 64. In addition to or in addition to the restrictor 64, a check valve could also be provided, for example. The restrictor 64 limits the possible volume flow through the return path 62. The restrictor 64 allows here only a small part of the compressed air flow along the first ventilation path 18, that is, a compressed air flow from the main port 16, via the relay valve 56 and the second holding valve 34 to the first redundant ventilation 14, the passage through the return path 62. that the control port 56.3 of the relay valve 56 can be vented even with the first compressed air path 18 released via the fourth holding valve 52, so as to close the relay valve 56 or to switch the bistable valve unit 30 to the second switching position 40, in which the first compressed air path 18 is interrupted.

If both the first control unit 26 and the second control unit 28 have an error, the second holding valve 34 also switches to the open state, so that an emergency braking function can also be realized by the parking brake redundancy unit 10 of the fifth embodiment.

In emergencies, the main port 16 but optionally also via the second ventilation path 46 or through the first holding valve 32 and the fourth holding valve 52 to the second redundant ventilation 48 can be connected and thus vented. This may be advantageous, for example, if the second holding valve 34 has a mechanical fault and is no longer switchable to the open position.

embodiments of the invention and that various changes and modifications may be made thereto without departing from the spirit and scope of the invention as defined in the appended claims.

### REFERENCE SIGNS PART OF THE DESCRIPTION

1 Parking brake device
2 Parking brake valve unit
4 Supply port
6 Parking brake control unit
8, 8a, 8b Spring accumulator ports
10 Parking brake redundancy unit
12 Parking brake pressure air path
14 Redundant ventilation
16 Main port
18 First ventilation path
22 First redundancy valve unit
24 Second redundancy valve unit
26 First control unit
28 Second control unit
30 Bistable valve unit
31 Bistable valve
32 First monostable holding valve
34 Second monostable holding valve
34.1 First path port
34.2 Second path port
34.3 Venting of the second holding valve
36 First switching position
38 Ventilation position
40 Second switching position
42 First pressure sensor
44 Second pressure sensor
46 Second ventilation path
48 Second redundant ventilation
50 Third holding valve
52 Fourth holding valve
54 Pneumatically switchable valve
56 Relay valve
56.1 Relay valve input port
56.2 Relay valve outlet port
56.3 Pneumatic control port
58 First path section
60 Second path section
62 Return path
64 Restrictor
200 Electronically controllable pneumatic braking system
202 Rear axle brake circuit
204 Front axle brake circuit
206 First compressed-air reservoir
207 Trailer brake circuit
208a-208f Service brake actuators
208a, 208b Front axle brake actuators
208c, 208d, Rear axle brake actuators 208e, 208f
209 Trailer module
210 Second compressed-air supply
212 Primary system
214 Primary control unit
216 Vehicle bus
218 Unit for autonomous driving
220 First supply line
222 First voltage source
224 First service axle modulator
228 Front axle modulator
230 Supply port
232.1 First service brake pressure port
232.2 Second service brake pressure port
234 Wheel speed sensor
236 Second service axle modulator
237 Rear axle modulator
238 ABS valves
240 Central module
241 Secondary system
242 Secondary control unit
244 Second supply line
246 Second voltage source
248 Redundancy bus
250 Redundancy axle modulator
252 Redundancy brake pressure port
254c-254f Spring brake cylinders
256 First redundancy signal line
258 Second redundancy signal line
260 Select-High valve
262 Push-pull valve
264 Foot brake pedal
300 Vehicle
302 Utility vehicle
HA1 First rear axle
HA2 Second rear axle
pB1 First service brake pressure
pB2 Second service brake pressure
pB3 Third service brake pressure
pBR1 Redundancy brake pressure
pFS Parking brake pressure
SA Braking demand signals
SB Service brake signals
SD Wheel speed signals
SFS Parking brake signal
VA Front axle

1. An electropneumatic parking brake device for pressurizing and venting at least one spring brake cylinder of an at least partially electronically controllable pneumatic braking system for a vehicle, the electropneumatic parking brake device comprising:
an electropneumatic parking brake valve unit having a supply port for receiving reservoir pressure from a compressed-air reservoir and a parking brake control unit;
said electropneumatic parking brake valve unit being configured to control a parking brake pressure at least at one spring accumulator port as a function of a parking brake signal;
an electropneumatic parking brake redundancy unit configured to connect a parking brake pressure air path to a ventilation for venting the at least one spring brake cylinder independently of said electropneumatic parking brake valve unit;
said electropneumatic parking brake redundancy unit having a first ventilation path including a main port for receiving a pressure of said parking brake pressure air path, a first electropneumatic redundancy valve unit, a second electropneumatic redundancy valve unit, and a redundant ventilation into an environment;
said first electropneumatic redundancy valve unit being configured to be controlled by a first control unit;
said second electropneumatic redundancy valve unit being configured to be controlled by a second control unit which is independent of said first control unit; and,
said electropneumatic parking brake redundancy unit being configured to connect said main port via said first ventilation path of said electropneumatic parking brake redundancy unit to said redundant ventilation in order to vent said main port directly into the environment.

2. The electropneumatic parking brake device of claim 1, wherein at least one of said first control unit and said second control unit is independent of said parking brake control unit.

3. The electropneumatic parking brake device of claim 1, wherein said parking brake control unit includes said first control unit or said second control unit.

4. The electropneumatic parking brake device of claim 1, wherein said first electropneumatic redundancy valve unit has a bistable valve unit having a first position and a second position; said first position is a ventilation position in which said bistable valve unit allows a pneumatic connection of said main port with said redundant ventilation; and, said bistable valve unit in said second switching position interrupts said first ventilation path.

5. The electropneumatic parking brake device of claim 4, wherein said first electropneumatic redundancy valve unit has a first monostable holding valve connected in series along said first ventilation path with said bistable valve unit.

6. The electropneumatic parking brake device of claim 4, wherein said second electropneumatic redundancy valve unit has a second monostable holding valve connected in series along said first ventilation path with said bistable valve unit.

7. The electropneumatic parking brake device of claim 6, wherein said second monostable holding valve is arranged along said first ventilation path between said bistable valve unit and said first monostable holding valve.

8. The electropneumatic parking brake device of claim 4 further comprising:
a second redundant ventilation and a second ventilation path configured to be vented via said second redundant ventilation; and,
said bistable valve unit being configured to be controlled via said second ventilation path.

9. The electropneumatic parking brake device of claim 8, wherein:
said bistable valve unit has a first electronically switchable monostable holding valve arranged in said second ventilation path, and a pneumatically switchable third holding valve is arranged in said first ventilation path and includes a pneumatic control port connected to said second ventilation path; and,
said second electropneumatic redundancy valve unit has a second electronically switchable monostable holding valve arranged in said first ventilation path.

10. The electropneumatic parking brake device of claim 9, wherein said pneumatically switchable third holding valve is a relay valve.

11. The electropneumatic parking brake device of claim 9 further comprising a return path connecting an outlet port of said pneumatically switchable third holding valve with said pneumatic control port of said pneumatically switchable third holding valve.

12. The electropneumatic parking brake device of claim 11 further comprising at least one of a restrictor and a check valve disposed in said return path.

13. The electropneumatic parking brake device of claim 1, wherein said electropneumatic parking brake redundancy unit has at least one pressure sensor for detecting a pressure in said first ventilation path.

14. The electropneumatic parking brake device of claim 1 further comprising a flow limiter which limits a maximum volume flow through said parking brake redundancy unit.

15. An electronically controllable pneumatic braking system for a vehicle, the electronically controllable pneumatic braking system comprising:
a first front axle brake actuator;
a second front axle brake actuator;
a first rear axle brake actuator;
a second rear axle brake actuator;
a primary system including a primary control unit for at least one of controlling said first front axle brake actuator and said second front axle brake actuator and controlling said first rear axle brake actuator and said second rear axle brake actuator; and,
an electropneumatic parking brake device for pressurizing and venting at least one spring brake cylinder;
said electropneumatic parking brake device including an electropneumatic parking brake valve unit and an electropneumatic parking brake redundancy unit;
said electropneumatic parking brake valve unit having a supply port for receiving reservoir pressure from a compressed-air reservoir and a parking brake control unit;
said electropneumatic parking brake valve unit being configured to control a parking brake pressure at least at one spring accumulator port as a function of a parking brake signal;
said electropneumatic parking brake redundancy unit being configured to connect a parking brake pressure air path to a ventilation for venting the at least one spring brake cylinder independently of said electropneumatic parking brake valve unit;
said electropneumatic parking brake redundancy unit having a first ventilation path including a main port for receiving a pressure of said parking brake pressure air path, a first electropneumatic redundancy valve unit, a second electropneumatic redundancy valve unit, and a redundant ventilation into an environment;
said first electropneumatic redundancy valve unit being configured to be controlled by a first control unit;
said second electropneumatic redundancy valve unit being configured to be controlled by a second control unit which is independent of said first control unit;
said electropneumatic parking brake redundancy unit being configured to connect said main port via said first ventilation path of said electropneumatic parking brake redundancy unit to said redundant ventilation in order to vent said main port directly into the environment; and,
said at least one first spring brake cylinder includes a spring accumulator brake cylinder connected to said at least one spring accumulator port of said electropneumatic parking brake valve unit.

16. The electronically controllable pneumatic braking system of claim 15, wherein said at least one first spring brake cylinder is connected to said main port of said parking brake redundancy unit; and, said electropneumatic parking brake redundancy unit is switchable in order to connect said at least one spring brake cylinder via said first ventilation path to said redundant ventilation in order to vent said at least one first spring brake cylinder.

17. The electronically controllable pneumatic braking system of claim 15, wherein said main port is connected to a first compressed-air reservoir of the electronically controllable pneumatic braking system; and, said electropneumatic parking brake redundancy unit is switchable in order to connect at least said first compressed-air reservoir via said first ventilation path to said redundant ventilation in order to vent said first compressed-air reservoir.

18. The electronically controllable pneumatic braking system of claim 15, wherein said primary control unit is or includes said first control unit.

19. The electronically controllable pneumatic braking system of claim 15 further comprising:
a secondary system having a secondary control unit; and,
said secondary system being configured to at least one of control said first front axle brake actuator and said second front axle brake actuator and control said first rear axle brake actuator and said second rear axle brake actuator if a fault is determined in said primary system.

20. The electronically controllable pneumatic braking system of claim 19, wherein said secondary control unit is or includes said second control unit.

21. The electronically controllable pneumatic braking system of claim 15 further comprising:
a first voltage source;
a second voltage source;
said first voltage source being provided for supplying said first control unit with electrical voltage; and,
said second voltage source being provided for supplying said second control unit with electrical voltage.

22. A vehicle comprising at least one front axle, at least one first rear axle and the electronically controllable pneumatic braking system of claim 15.

23. The vehicle of claim 22, wherein the vehicle is a utility vehicle.

24. A method for operating an electronically controllable pneumatic braking system for a vehicle, the vehicle including at least one spring brake cylinder and an electropneumatic parking brake device for pressurizing and venting at least one spring brake cylinder of an at least partially electronically controllable pneumatic braking system for a vehicle, the electropneumatic parking brake device including an electropneumatic parking brake valve unit and an electropneumatic parking brake redundancy unit, the electropneumatic parking brake valve unit having a supply port for receiving reservoir pressure from a compressed-air reservoir and a parking brake control unit; the electropneumatic parking brake valve unit being configured to control a parking brake pressure at least at one spring accumulator port as a function of a parking brake signal; the electropneumatic parking brake redundancy unit being configured to connect a parking brake pressure air path to a ventilation for venting the at least one spring brake cylinder independently of the electropneumatic parking brake valve unit; the electropneumatic parking brake redundancy unit having a first ventilation path including a main port for receiving a pressure of the parking brake pressure air path, a first electropneumatic redundancy valve unit, a second electropneumatic redundancy valve unit, and a redundant ventilation into an environment; the first electropneumatic redundancy valve unit being configured to be controlled by a first control unit; the second electropneumatic redundancy valve unit being configured to be controlled by a second control unit which is independent of the first control unit; the electropneumatic parking brake redundancy unit being configured to connect the main port via the first ventilation path of the parking brake redundancy unit to the redundant ventilation in order to vent the main port directly into the environment; wherein the first electropneumatic redundancy valve unit has a bistable valve unit having a first position and a second position; the first position is a ventilation position in which the bistable valve unit allows a pneumatic connection of the main port with the redundant ventilation; and, the bistable valve unit in the second switching position interrupts the first ventilation path, wherein the spring accumulator port of the electropneumatic parking brake valve unit for pressurizing the at least one spring brake cylinder is connected to a parking brake pressure to which the at least one spring brake cylinder is connected; and the main port of the electropneumatic parking brake redundancy unit is connected to a parking brake pressure air
path of the braking system, the method comprising:
determining whether there is an at least partially autonomous operating mode or a manual operating mode of the braking system;
switching the bistable valve unit to the ventilation position if there is the at least partially autonomous operating mode of the braking system;
switching the bistable valve unit to the second position if there is the manual operating mode of the braking system; and,
pressurizing the at least one spring brake cylinder by the electropneumatic parking brake valve unit.

25. The method of claim 24, the method, in an event that there is the at least partially autonomous operating mode of the braking system, further comprising:
determining whether there is a fault with the electropneumatic parking brake valve unit;
determining whether there is a parking brake request; and,
at least temporarily interrupting the first ventilation path by a first holding valve if no fault with the electropneumatic parking brake valve unit is determined and no parking brake request is determined; or,
opening the first holding valve if a fault of the electropneumatic parking brake valve unit is determined and the parking brake request is determined in order to at least partially release the first ventilation path.

26. The method of claim 25 further comprising:
at least secondarily interrupting the first ventilation path by a second holding valve if no fault of the parking brake control unit is determined and no parking brake request is determined.

27. The method of claim 26, wherein said at least secondarily interrupting by the second holding valve takes place when the first holding valve releases the first ventilation path, no fault of the parking brake control unit is determined and no parking brake request is determined.

28. The method of claim 27, wherein the first holding valve for said at least secondarily interrupting the first ventilation path is controlled by a first control unit; the second holding valve for said at least secondarily interrupting the first ventilation path is controlled by a second control unit; and, the first control unit and the second control unit are connected and are configured to determine whether an other of the first control unit and second control unit respectively releases or interrupts the first ventilation path.

29. The method of claim 28, wherein the first control unit and the second control unit are connected via a CAN bus.
